(19) United States
(12) Patent Application Publication
(10) Pub. No.: US 2019/0162168 A1
(43) Pub. Date: May 30, 2019

(54) ROTOR POLE FOR A GENERATOR OF A WIND ENERGY PLANT AND WIND ENERGY PLANT GENERATOR AND METHOD FOR PRODUCING A ROTOR POLE

(71) Applicant: Wobben Properties GmbH, Aurich (DE)

(72) Inventors: Jochen RÖER, Ganderkesee (DE); Jan Carsten ZIEMS, Aurich (DE)

(21) Appl. No.: 16/300,516

(22) PCT Filed: May 2, 2017
(86) PCT No.: PCT/EP2017/060353

§ 371 Date: Nov. 9, 2018

(30) Foreign Application Priority Data
May 11, 2016 (DE) 10 2016 108 710.6

(51) Int. Cl. F03D 9/25; H02K 1/24; H02K 3/52; H02K 7/18; H02K 9/22

(52) U.S. Cl. CPC F03D 9/255; H02K 1/24; H02K 9/22; H02K 7/1838; H02K 3/527

(57) ABSTRACT

A rotor pole for a generator of a wind power installation is provided. The rotor pole includes a pole pack, which may be laminated. The pole pack has a pole shank, a pole head and at least one aluminum winding. The at least one aluminum winding may be a flat aluminum ribbon, arranged around the pole shank. The pole pack furthermore has an intermediate layer, which is arranged between the pole pack and the aluminum winding, wherein the intermediate layer is produced from aluminum. A wind power installation generator and to a method for producing a rotor pole are also provided.

### BACKGROUND

### Technical Field

The present invention relates to a rotor pole of a generator of a wind power installation, a wind power installation generator and a method for producing a rotor pole.

### Description of the Related Art

Wind power installations, in particular also gearless wind power installations, are known according to the prior art. Wind power installations are driven by an aerodynamic rotor, which is connected directly to a rotor of a generator. The kinetic energy obtained from the wind is converted into electrical energy by the movement of the rotor in the generator. The rotor of the generator accordingly rotates at the same slow rotation speed as the aerodynamic rotor.

In order to take into account a slow rotation speed of this kind, the generator has a generator diameter, which is relatively large in relation to the nominal power, preferably of a few meters, and has a large air gap diameter. The air gap is delimited by rotor poles having pole packs on the rotor side. The pole packs consist of a material block or of a large number of punched pole pack laminations, which are layered one on top of the other and, for example, are welded to one another to form the pole packs.

According to the prior art, the pole pack laminations of the pole packs have a pole shank region and a pole head region, wherein the pole head region projects laterally beyond the pole shank region. The pole shank region is also referred to as pole core and the pole head region is also referred to as pole shoe. A pole pack of this kind is usually arranged with the pole shank end, which is located opposite the pole head region, on the yoke of the rotor.

The pole shank regions of the pole pack laminations of the pole packs, which pole shank regions are arranged one behind the other, are provided with a winding, which can also be called a rotor winding, and an electric field current is supplied to this winding. As a result, magnetic excitation is generated by the pole packs and the corresponding winding together with the field current. This magnetic excitation leads to the pole packs with the winding serving as magnetic poles of the rotor of the generator, in particular a synchronous generator.

In this case, it is known to arrange a fiber composite material or a glass-fiber reinforced plastic or an insulation paper between the winding and the pole shank. Said fiber composite material or glass-fiber reinforced plastic has a thickness of several millimeters (mm), for example 3 mm. This thickness is necessary in order to protect the windings against interferences, such as sharp edges, in the contour of the pole packs welded to one another and to absorb tensile forces, which are generated, for example, by copper wires. Such fiber composite materials or glass-fiber reinforced plastics have proven to be advantageous and are used in the meantime not only for copper windings but also for windings made of aluminum wire.

However, a disadvantage of said fiber composite materials or glass-fiber reinforced plastics is that they guarantee poor heat transmission from the winding to the coil core, in particular since they are very thick. Furthermore, glass-fiber reinforced plastic and fiber composite material are very expensive since they are complicated to produce.

A further disadvantage is that an aluminum winding expands under heating in the direction of the depth of the generator to a greater extent than the pole core. In contrast to a copper winding, this greater longitudinal expansion in the case of soft aluminum with good electrical conductivity cannot be offset completely by means of prestressing the conductor material. Adhesive bonding of an aluminum winding to the fiber composite material or to the insulation paper could therefore detach under heating owing to the longitudinal expansion that is greater in comparison with the pole core. Detachment of the windings would result in the risk of the windings being dislodged out of their predefined positions during operation of the generator.

The German Patent and Trademark Office has searched the following prior art in the priority application relating to the present application: DE 10 2004 046 904 A1, DE 10 2011 006 680 A1, DE 10 2011 006 682 A1 and EP 1 517 426 B1.

### BRIEF SUMMARY

The risk of the winding detaching from the pole core is reduced as described herein. It is proposed to makes it possible for the development of heat in the windings to be better dissipated to the pole shank region or pole core. Further, it is proposed to makes it possible for the rotor of a wind power installation generator to be produced in a more expedient manner than has previously been known in the prior art.

According to the invention, a rotor pole for a generator of a wind power installation is proposed. The rotor pole has a pole pack, which is embodied in laminated fashion. The pole pack comprises a pole shank and a pole head. At least one aluminum winding is arranged around the pole shank. Furthermore, an intermediate layer is arranged between the pole shank and the aluminum winding, wherein the intermediate layer is produced with aluminum. Said intermediate layer can also be called a winding body.

Providing an intermediate layer with aluminum protects an aluminum winding to a sufficient extent against interfering contours of the winding core, which are produced, for example, through welding of the pole laminations. Furthermore, the transmission of heat by aluminum is significantly better than by glass-fiber reinforced plastic or fiber composite materials, with the result that the development of heat in the aluminum windings can be better dissipated to the pole core or pole shank. Aside from that, aluminum is significantly cheaper than fiber composite material.

According to a first embodiment, the intermediate layer is produced from aluminum sheet or aluminum extruded profiles.

Aluminum sheets or aluminum extruded profiles of this kind can be produced particularly easily and are available in large numbers in various thicknesses and are therefore cheap to provide. Furthermore, aluminum can be brought into a desired shape for the intermediate layer in a simple manner, for example by laser cutting or stamping, with the result that the processing thereof is also very cheap.

According to a further embodiment, the intermediate layer is galvanically isolated from the pole pack and/or from the winding, in particular by way of a coating layer or an insulation paper, preferably aramid paper. Although the windings of a pole are also preferably provided with a coating layer and therefore insulated with respect to the pole pack so that a flow of current from the windings into the pole pack is prevented, an insulation paper or a further coating layer on the intermediate layer nevertheless makes it possible that, even in the event of an insulation layer of the winding itself being damaged, no current flows from the windings into the pole pack.

According to a further embodiment, the intermediate layer of a pole pack comprises at least four parts. These four parts correspond to two side elements and two head elements. The four parts are arranged around the pole shank of the pole pack in such a way as to preferably completely surround the pole shank of the pole pack on the free sides thereof. In this case, the head elements are arranged on the end sides of the pole pack and the side elements are arranged on the sides of the pole pack, which sides are formed by layering the laminations.

This ensures that the windings of a pole are protected in the entire region of the pole shank in the case of any irregularities in the pole pack.

According to a further embodiment, each of the side elements have in each case a web running along the side element, which engages into a groove, which runs along the side of the pole shank formed by layering the laminations. The side elements can therefore be mounted on a connecting line between the end sides of the pole pack in displaceable fashion with respect to the sides of the pole pack by way of the groove/tongue connection.

In the event that the winding now heats up during operation, the aluminum of the intermediate layer that is likewise heated expands to a greater extent than the pole pack, which is produced, for example, from sheet-metal plates. By way of the groove/tongue connection, the intermediate layer can advantageously expand comparatively more than the pole pack, without stresses arising.

According to a further embodiment, the groove/tongue or web/tongue connection between the side elements and the pole pack is designed as a dovetail tongue/dovetail groove connection. Accordingly, the tongue or the web is a dovetail tongue and the groove is a dovetail groove. As a result, the intermediate layer is advantageously connected to the pole pack in such a way that the intermediate layer is prevented from lifting off from the pole shank, wherein displacement on a connecting line between the ends of the pole pack continues to be permitted.

According to a further embodiment, the grooves on the opposite sides of the pole pack are arranged at different heights of the pole shank with respect to the bottom side of the pole, namely the pole shank base end, which can be connected to the rotor yoke. As a result of this, the flux of the magnetic field through the pole pack advantageously experiences only slightly less interference than in the event that the grooves were provided at the same height.

Furthermore, the grooves and tongues or webs are arranged so that the groove on the one side of the pole pack, which side is formed by layering the laminations, has the same spacing from the pole head as the groove on the other opposite side of the pole pack has from the pole shank base end of the pole pack, which pole shank base end is opposite the pole head.

That is to say that grooves are accordingly arranged on both sides of the pole shank, wherein the groove on the one side runs at a substantially constant spacing from the pole head. On the other side of the pole head, the groove is spaced apart from the pole shank base end at a spacing that corresponds to the spacing of the groove on the other side with respect to the pole head. As a result, identically produced side elements can be used for both sides of the pole head. The production outlay for the side elements of the intermediate layer is therefore reduced.

According to a further embodiment, the side elements have a concave bend as seen from the side that has the web or the tongue. This ensures that, after connection to the pole shank, in particular by insertion of the web designed as a dovetail tongue into the groove of the pole pack, which groove is designed as a dovetail groove, the side elements make contact with the pole pack over the greatest area possible. This ensures particularly good thermal conductivity so that heat generated in the aluminum windings is dissipated particularly well into the pole pack by means of the intermediate layer.

According to a further embodiment, each of the side elements is secured to the pole pack in each case using a single screw. This improves the secure hold of the side elements to the pole packs.

According to a further embodiment, the intermediate layer has a maximum thickness of less than 3 mm, preferably less than 2 mm. Using a thin intermediate layer of less than 3 mm or even less than 2 mm ensures a high cost saving compared to fiber composite materials as intermediate layer, wherein sufficient protection of the winding is guaranteed on account of the use of aluminum as intermediate layer.

According to a further embodiment, the head elements each have a shape corresponding to a semicircle or a half ellipse. Each one of the side elements is then connected to the ends of the semicircle or the half ellipse. The bend or the diameter of the semicircle or the half ellipse are furthermore selected in such a way as to prevent or to counteract an excessive plastic deformation of an aluminum winding.

An excessive plastic deformation of the winding would result in disadvantageous line properties in the bend location, which could lead to an uneven flow of current in the winding and consequently to heating at the bend locations. As a result, during operation, the winding could reach temperatures that could lead to destruction of the winding. In addition, the semicircular or elliptical head pieces permit a more uniform winding process, since a uniform pull is exerted during winding by a winding machine, which pull leads to comparatively stronger pulling stress in the transition from winding a long to a short side or vice versa and the windings could therefore be damaged at sharp corners.

According to a further embodiment, the connecting regions of the side elements are designed with the head elements to ensure an edge-free transition between the side and head elements. This protects the winding further against damage.

According to a further embodiment, the edge shape of the edges of the side elements, which are not connected to the head elements, in the contact region having the pole head is adapted to the shape of the pole head. This makes it possible to improve the magnetic flux in the side elements.

The invention further comprises a wind power installation generator, in particular a wind power installation synchronous generator, wherein the wind power installation generator has a stator and a rotor. The rotor has at least one rotor pole, preferably according to one of the embodiments mentioned above, having a pole pack. The pole pack has a pole shank and at least one winding wound around the pole shank. The wind power installation generator furthermore has an intermediate layer between the pole pack and the winding, which intermediate layer is produced with aluminum.

The invention further relates to a method for producing a rotor pole, in particular according to one of the embodiments mentioned above, wherein a pole pack is generated by stacking laminations one on top of the other and a winding is arranged around the pole pack in the region of a pole shank of the pole pack. Prior to the arrangement of the winding, an intermediate layer with or made of aluminum is arranged on the pole pack in the region of the pole shank.

### BRIEF DESCRIPTION OF THE SEVERAL VIEWS OF THE DRAWINGS

Further embodiments result based on the exemplary embodiments explained in more detail in the figures.

FIG. 1 shows a wind power installation,

FIG. 2 shows a schematic side view of a generator,

FIG. 3 shows a pole pack having an intermediate layer,

FIG. 4 shows an intermediate layer,

FIG. 5 shows the upper part of an intermediate layer on the pole pack

FIG. 6 shows an enlarged view of a dovetail groove of the pole pack,

FIG. 7 shows a plan view of an end region of the intermediate layer and

FIGS. 8a and 8b show a plan view of the head elements of the intermediate layer in various shapes.

### DETAILED DESCRIPTION

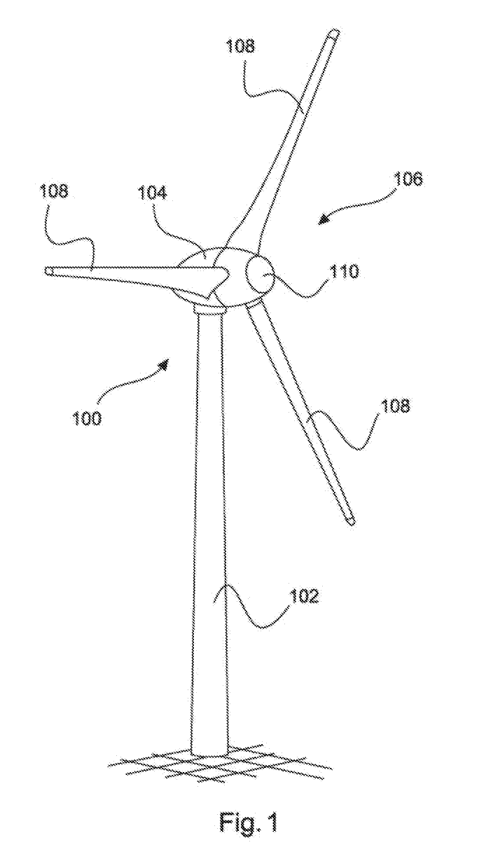

FIG. 1 shows a schematic representation of a wind power installation according to the invention. The wind power installation 100 has a tower 102 and a nacelle 104 on the tower 102. On the nacelle 104 there is provided an aerodynamic rotor 106 with three rotor blades 108 and a spinner 110. When the wind power installation is in operation, the aerodynamic rotor 106 is set in rotation by the wind and thus also turns a rotor of a generator, which is coupled either directly or indirectly to the aerodynamic rotor 106. The electric generator is arranged in the nacelle 104 and generates electrical energy. The pitch angles of the rotor blades 108 can be changed by pitch motors at the rotor blade roots of the respective rotor blades 108.

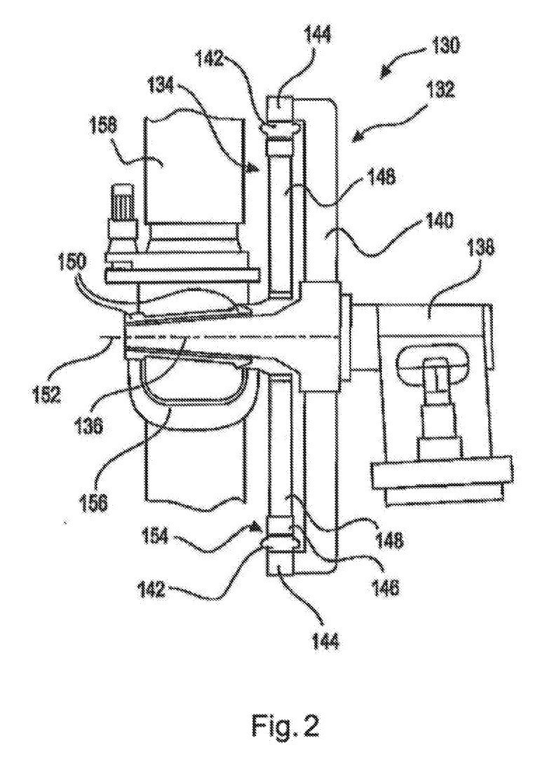

FIG. 2 shows a schematic side view of a generator 130. Said generator has a stator 132 and an electrodynamic rotor 134 mounted such that it can rotate relative to said stator, and is secured by way of its stator 132 to a machine support 138 by means of a journal 136. The stator 132 has a stator support 140 and stator laminated cores 142, which form stator poles of the generator 130 and which are fastened by means of a stator ring 144 to the stator support 140.

The electrodynamic rotor 134 has rotor poles 146, which are mounted on the journal 136 by means of a rotor support 148, which can also be called a yoke or rotor yoke, and bearings 150 such that they can rotate about the rotation axis 152. The stator laminated cores 142 and rotor poles 146 are separated by only a narrow air gap 154, which is a few millimeters thick, in particular less than 6 mm, but has a diameter of several meters (m), in particular more than 4 m.

The stator laminated cores 142 and the rotor poles 146 form in each case one ring and, together, are also annular, so that the generator 130 is a ring generator. The electrodynamic rotor 134 of the generator 130 intentionally rotates together with the rotor hub 156 of the aerodynamic rotor 106, roots of rotor blades 158 of said aerodynamic rotor being indicated.

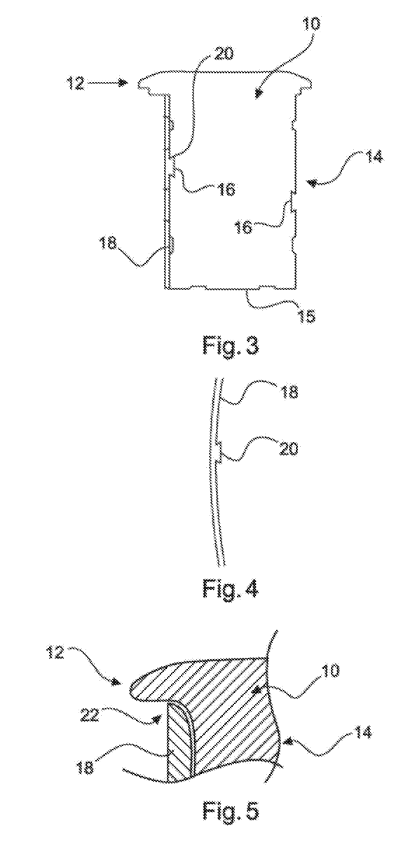

FIG. 3 shows a pole pack 10 of a rotor pole 146, wherein the pole pack 10 has a pole head 12 and a pole shank 14. The pole shank 14 has a pole shank base end 15. The pole shank base end 15 serves to secure the rotor yoke 148. The pole pack 10 is illustrated from the view of one of the end sides of the pole pack 10. Two dovetail grooves 16 are provided in the pole shank 14. An intermediate layer 18 is arranged on one side of the pole shank 14 in the region of the pole shank 14. The intermediate layer 18 is produced from aluminum and has a web 20, wherein the web 20 has a dovetail tongue shape and engages into the dovetail groove 16. As a result, the intermediate layer 18 is held on the pole shank 14 of the pole pack 10.

For the sake of better clarity, FIG. 3 illustrates only a part of the intermediate layer 18. In the case of a complete rotor pole 146, according to one embodiment, the pole shank 14 is completely surrounded by the intermediate layer 18.

FIG. 4 shows an individual section of the intermediate layer 18 from FIG. 3 with respect to the rotor pole 146. In this case, the web 20, which can also be referred to as tongue and which has a dovetail tongue shape, can be now be seen in detail. Furthermore, it can be seen that the intermediate layer 18 has a concave bend. This ensures that, after connection of the web or the tongue 20 to the groove 16, the intermediate layer 18 has the greatest possible surface contact with the pole shank 14 of the pole pack 10.

FIG. 5 shows an enlarged illustration of a section of the pole pack 10 in the region of the transition between the pole shank 14 and the pole head 12. In this region, the intermediate layer 18 is adapted to the shape of the pole head 12 in the region 22. This improves the magnetic flux in the intermediate layer 18.

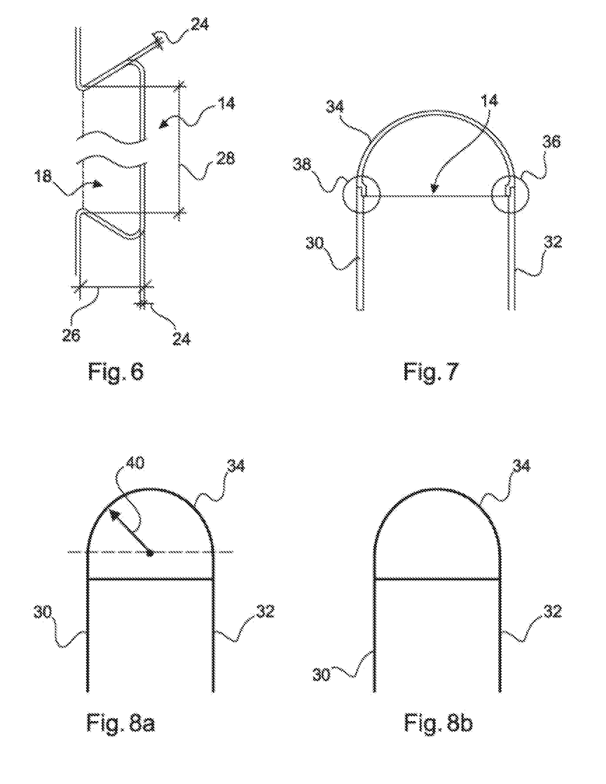

FIG. 6 shows the enlargement of a connection of the intermediate layer 18 to the pole pack 10 by the dovetail groove/dovetail tongue connection. The spacing 24 between the intermediate layer 18 and the pole shank 14 is, for example, 0.1 mm. This ensures very good heat conduction. The depth 26 of the groove 16 or the height 26 of the tongue 20 is, for example, 2 mm. The width 28 of the groove 16 at the narrowest side is, for example, 2 cm.

FIG. 7 shows the plan view of three parts of a four-part intermediate layer 18, wherein, in this case, the end region of the pole shank 14 with respect to the pole head 12 is also illustrated by way of example without a pole head 12. Accordingly, two side elements 30, 32 of the intermediate layer 18 and a head element 34 of the intermediate layer 18 are illustrated. In connecting regions 36, 38, the intermediate layer 18 has an edgeless transition in each case between ends of the head element 34 and one of the side elements 30, 32.

FIGS. 8a and 8b show differently shaped head elements 34 of the intermediate layer 18. In FIG. 8a, the head element 34 has a semicircular shape with a radius 40. In FIG. 8b, the head element 34 has a rather half-elliptical shape. Both shapes, as illustrated in FIGS. 8a and 8b, of the head element 34 serve to wind an aluminum winding subsequently about the pole shank region 14 and the intermediate layer 18 so that deformation of the winding, which is produced, in particular, from flat aluminum ribbon, is counteracted.

1. A rotor pole for a generator of a wind power installation, comprising:
a pole pack including:
a pole shank having arranged thereon at least one aluminum winding of at least one of: flat aluminum ribbon or flat aluminum enameled wire,
an intermediate layer, made from aluminum, arranged between the pole shank and the at least one aluminum winding, and
a pole head.

2. The rotor pole as claimed in claim 1, wherein the intermediate layer is produced from an aluminum sheet or aluminum extruded profiles.

3. The rotor pole as claimed in claim 1, comprising:
a coating layer or an insulation paper disposed between the intermediate layer and at least one of: the pole pack or the at least one aluminum winding and operative to galvanically isolate the intermediate layer from the at least one of: the pole pack or the at least one aluminum winding.

4. The rotor pole as claimed in claim 1, wherein the intermediate layer has at least four parts including:
two side elements arranged on respective sides of the pole pack, wherein the sides are formed by layering laminations, and
two head elements arranged on respective end sides of the pole pack and completely surrounding four parts of the pole shank on sides thereof.

5. The rotor pole as claimed in claim 4, wherein each side element has a web running along the side element or a tongue running along the side element, wherein the tongue is operative to engage into a groove running along a side pole shank formed by layering the laminations, wherein the two side elements are operative to be displaced with respect to the sides of the pole pack in the groove on a connecting line between the end sides of the pole pack.

6. The rotor pole as claimed in claim 5, wherein the web or the tongue of the side element is a dovetail tongue and the groove of the pole pack is a dovetail groove.

7. The rotor pole as claimed in claim 5, wherein webs or grooves on opposite sides of the pole pack, are arranged at different heights.

8. The rotor pole as claimed in claim 7, wherein a first spacing of a first groove on a first side of the pole pack is, equal to a second spacing of a second groove on second side of the pole pack opposite to the first side, wherein the first and second sides are formed by layering the laminations.

9. The rotor pole as claimed in claim 5, wherein the two side elements each have a concave bend on a side having the web.

10. The rotor pole as claimed in claim 4, wherein the two side elements, are each secured to the pole pack using a single screw.

11. The rotor pole as claimed in claim 1, wherein the intermediate layer has a maximum thickness of 3 millimeters (mm).

12. The rotor pole as claimed in claim 4, wherein the two head elements each have a shape corresponding to a semicircle or a half ellipse and corresponding to ends of each of the two side elements to which the two head elements are respectively, connected, wherein the semicircle or the half ellipse has a bend or a radius operable to counteract plastic deformation of the at least one aluminum winding or insulation damage.

13. The rotor pole as claimed in claim 4, wherein connecting regions of the two side elements and the two head elements have an edge-free transition between the two side elements.

14. The rotor pole as claimed in claim 1, wherein an edge shape of the intermediate layer in a contact region having the pole head is adapted to the shape of the pole head.

15. A wind power installation generator of a wind power installation, comprising:
a stator, and
a rotor having at least one rotor pole including:
a laminated pole pack having:
a pole shank,
a pole head,
at least one aluminum winding made of at least one of: flat aluminum wire or flat aluminum enameled wire, wherein the at least one aluminum winding is arranged around the pole shank, and
an intermediate layer is arranged between the laminated pole pack and the at least one aluminum winding, wherein the intermediate layer is at least partly made from aluminum.

16. A method for producing a rotor pole, comprising:
stacking laminations to generate a pole pack or casting the pole pack as a material block,
arranging an intermediate layer made from aluminum on a pole shank of the pole pack, and
after arranging the intermediate layer, arranging a winding around the pole pack.

17. The rotor pole as claimed in claim 1, wherein the pole pack is laminated.

18. The rotor pole as claimed in claim 3, wherein the coating layer or the insulation paper is aramid paper wherein the pole pack is laminated.

19. The rotor pole as claimed in claim 11, wherein the maximum thickness is 2 mm.
